(19) United States
(12) Patent Application Publication
(10) Pub. No.: US 2019/0327316 A1
(43) Pub. Date: Oct. 24, 2019

(54) APPLICATION SHARING DEVICE AND METHOD

(71) Applicant: ZTE CORPORATION, Shenzhen, Guangdong (CN)

(72) Inventor: Lewen LIANGWANG, Shenzhen, Guangdong (CN)

(21) Appl. No.: 16/300,619

(22) PCT Filed: Jul. 5, 2016
(86) PCT No.: PCT/CN2016/088603

§ 371 Date: Nov. 12, 2018

(30) Foreign Application Priority Data
May 10, 2016 (CN) 201610305223.8

(51) Int. Cl. H04L 29/08

(52) U.S. Cl. CPC H04L 67/16; H04L 67/10

(57) ABSTRACT

Disclosed is an application sharing device applicable to a mobile terminal, the mobile terminal installing at least one application, the installed at least one application being an original application, the application sharing device comprising: a management module, configured to control launching of a new application, and generate a derived list, wherein the new application is the same application operating simultaneously with an original application, and the derived list includes information of the original application, and information of the new application corresponding to the original application; and a file sharing module, configured to obtain, when the mobile terminal shares a file, the original application or the new application that currently opens the shared file, search the derived list for the original application and/or the new application corresponding to the obtained application. There is also disclosed is an application sharing method.

### FIELD OF THE INVENTION

This disclosure relates to, but is not limited to, the field of data sharing processing, and relates to an application sharing device and method.

### BACKGROUND

When a mobile terminal normally loads an APP (Application), the system may detect an application package name, and automatically start the loaded APP. Each application registers a self-starting request capability set with the system, such as sharing capability, that is, after the self-starting sharing capability is registered, the system will display the application having sharing capability for a user to select once the user performs a sharing operation. At present, an application can run an instance process on a terminal, and can also run multiple other instance processes simultaneously for use by a user in a mobile terminal. The application with a unique package name information of the application is an original application, and multiple other instance processes that run at the same time are referred to as derived new applications, which are the processes run under the system application management, such as WeChat and Weibo. For the new application, since the self-starting application of current system is only the original application, the system only recognizes the unique package name information of the application rather than the new application. Therefore, the system is unable to enumerate the new application when displaying the application having sharing capability, such that the new application having sharing function cannot be displayed to the user in time, resulting in the lack of sharing function.

### SUMMARY

The following is a summary of the subject matter described in detail herein. This summary is not intended to limit the scope of the claims.

An embodiment of the disclosure provides an application sharing device which can facilitate the data sharing for the user.

According to the embodiment of the disclosure, there is provided the application sharing device applicable to a mobile terminal, the mobile terminal installing at least one application, the installed at least one application being an original application, the application sharing device comprising: a management module, configured to control launching of a new application, and generate a derived list, wherein the new application is the same application operating simultaneously with an original application, and the derived list includes information of the original application, and information of the new application corresponding to the original application; and a file sharing module, configured to obtain, when the mobile terminal shares a file, the original application or the new application that currently opens the shared file, search the derived list for the original application and/or the new application corresponding to the obtained application.

Optionally, the device further comprises a setting module, configured to generate an original list, wherein the original list includes the original application that is able to generate the new application, the original list includes a new application management tag, and the new application management tag controls whether the original application is authorized to generate the new application, wherein when the new application management tag corresponding to the original application in the original list is opened, the original application generates the new application.

Optionally, the file sharing module is further configured to display a found application having sharing capability in the original applications and/or the new applications for the user to select.

Optionally, the management module is configured to launch, when the new application management tag corresponding to the original application is opened, the at least one new application, and generate the derived list, wherein the derived list includes an original application package name ID, a new application list, an application name and an application icon, wherein the new application list includes a new application package name ID of the launched at least one new application.

Optionally, the file sharing module is further configured to judge whether the obtained application belongs to the original list, wherein if it is judged that the obtained application belongs to the original list, the file sharing module judges whether the obtained application has the new application management tag, if it is judged that the obtained application does not have the new application management tag, the file sharing module obtains at least one original application having the new application management tag in the original list, searches the new application list according to a correspondence relation between the original application package name ID of the obtained at least one original application and the new application package name ID, and displays an application name and application icon having the sharing capability set in the original list and the new application list for a user to select.

Optionally, the file sharing module is further configured to read, if it is judged that the obtained application belongs to the original list and has the new application management tag, the original application package name ID of the obtained application, search the new application list according to the correspondence relation between the original application package name ID and the new application package name ID, and display the application name and application icon having the sharing capability set in the new application list for the user to select.

Optionally, the file sharing module is further configured to read, if it is judged that the obtained application does not belong to the original list, the new application package name ID′ of the obtained application, search the original application package name ID corresponding to the new application package name ID′, and search the new application list according to the original application package name ID, and display the original application and the application name and application icon having the sharing capability set of the new application package name ID, except the new application package name ID′, in the new application list for the user to select.

An embodiment of the disclosure provides an application sharing method applicable to a mobile terminal, the mobile terminal installing at least one application, the installed at least one application being an original application, the application sharing method comprising: controlling launching of a new application and generating a derived list, wherein the new application is the same application operating simultaneously with the original application, and the derived list includes information of the original application and information of the new corresponding to the original application; and obtaining, if a mobile terminal shares a file, the original application or the new application that currently opens the shared file, and searching the derived list for the original applications and/or the new applications corresponding to the obtained application.

Optionally, the method further comprises: generating an original list, wherein the original list includes the original application that is able to generate the new application, the original list further includes a new application management tag, and the new application management tag is configured to control whether the original application is authorized to generate the new application, wherein if the new application management tag corresponding to the original application in the original list is opened, the original application generates the new application.

Optionally, the method further comprises: displaying a found application having the sharing capability in the original applications and/or the new applications for the user to select.

Optionally, the step of controlling the initiation of the new application and generating the derived list comprises: if the new application management tag corresponding to the original application is opened, launching at least one new application and generating the derived list, wherein the derived list includes the original application package name ID, a new application list, an application name, an application icon, wherein the new application list includes at least one new application package name ID of the launched new application.

Optionally, the method further comprises: judging whether the obtained application belongs to the original list, and if the obtained application belongs to the original list, judging whether the obtained application has the new application management tag; if the obtained application does not have the new application management tag, obtaining at least one original application having the new application management tag in the original list; and searching the new application list according to the correspondence relation between the original application package name ID of the obtained at least one original application and the new application package name ID, and displaying the application name and application icon having the sharing capability set in the original list and the new application list for the user to select.

Optionally, the method further comprises: if the obtained application belongs to the original list and has the new application management tag, reading the original application package name ID of the obtained application, searching the new application list according to the correspondence relation between the original application package name ID and the new application package name ID, and displaying the application name and application icon having the sharing capability set in the new application list for the user to select.

Optionally, the method further comprises: if the obtained application does not belong to the original list, reading the new application package name ID′ of the obtained application, searching the original application package name ID corresponding to the new application package name ID′, searching the new application list according to the original application package name ID, and displaying the original application and the application name and application icon having the sharing capability set of the new application package name ID, except the new application package name ID′, in the new application list for the user to select.

The application sharing method and device according to the embodiments of the present disclosure can easily complete the process of the file sharing of the new application. With the technical solution of the embodiment of the present disclosure, a new application can be displayed for the user to select when the user clicks the sharing function, thereby solving the lack of sharing function of the current new application and greatly improving the user experience.

An embodiment of the present invention further provides a computer readable storage medium, wherein the computer readable storage medium stores computer executable instructions, and when the computer executable instructions are executed, the application sharing method is implemented.

Other aspects will be apparent upon reading and understanding the accompanying drawings and detailed description.

### BRIEF DESCRIPTION OF THE DRAWINGS

FIG. 1 is a diagram showing functional module of an application sharing device according to a first embodiment of the disclosure;

FIG. 2 is a diagram showing functional module of an application sharing device according to a second embodiment of the disclosure;

FIG. 3 is a flow chat of an application sharing method according to a third embodiment of the disclosure; and

FIG. 4 is a flow chat of an application sharing method according to a fourth embodiment of the disclosure.

### REFERENCE NUMERALS

Application sharing device 1
Setting module 10
Management module 12
File sharing module 14
New application management tag 101
Original list 102
Derived list 121
New application list 122

### DETAILED DESCRIPTION OF THE EMBODIMENTS

The present disclosure will be further described in detail below in conjunction with the accompanying drawings and embodiments. It is understood that the specific embodiments described herein are merely illustrative of and not intended to limit the disclosure.

### First Embodiment

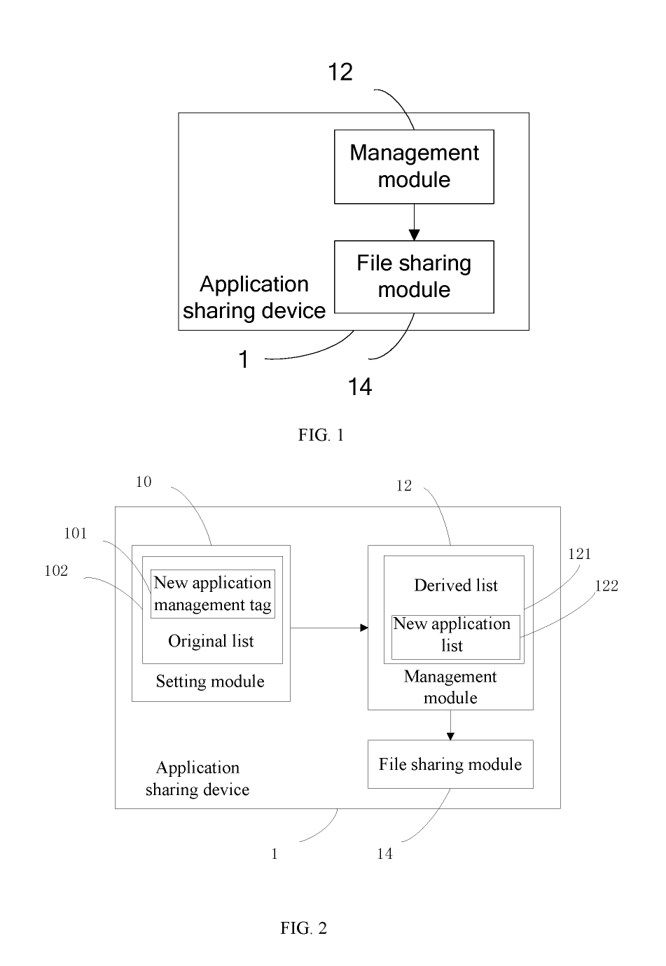

FIG. 1 is a diagram showing functional module of an application sharing device according to an embodiment of the disclosure. In this embodiment, the application sharing device 1 includes a management module 12 and a file sharing module 14. The management module 12 is coupled to the file sharing module 14. The application sharing device 1 is coupled to a mobile terminal. The mobile terminal installs at least one application thereon, and the installed at least one application is an original application. The function modules will be described in detail below.

The management module 12 is configured to control launching of a new application, and generate a derived list, wherein the new application is the same application operating simultaneously with an original application, and the derived list includes information of the original application, and information of the new application corresponding to the original application.

The file sharing module 14 is configured to obtain, when a mobile terminal shares a file, an application that currently opens the shared file, search the derived list for the original applications and/or the new applications corresponding to the obtained application, and display a found application having sharing capability in the original applications and/or the new applications for the user to select.

### Second Embodiment

FIG. 2 is a diagram showing functional module of an application sharing device according to a second embodiment of the disclosure. The application sharing device 1 in this embodiment includes a setting module 10, a management module 12, and a file sharing module 14. The setting module 10 includes an original list 102. The original list 102 includes a new application management tag 101. The management module 14 includes a derived list 121 and a new application list 122. The setting module 10 is coupled to the management module 12, the management module 12 is coupled to the file sharing module 14, and the application sharing device 1 is coupled to the mobile terminal. The mobile terminal installs at least one application thereon, and the installed at least one application is an original application. The function modules of the application sharing device according to this embodiment will be described in detail below in conjunction with FIG. 2.

The setting module 10 is configured to generate an original list 102, wherein the original list 102 includes an original application that can generate a new application, the original list 102 has at least one original application installed in the mobile terminal, the new application is the same application operating simultaneously with the original application, the original list 102 includes a new application management tag 101, and the new application management tag 101 controls whether the original application is authorized to generate the new application, wherein when the new application management tag corresponding to the original application in the original list is opened, the original application can generate the new application.

The management module 12 is configured to control the initiation of the new application and generate the derived list 121, wherein the new application is the same application operating simultaneously with the original application, and the derived list 121 includes information of the original application and information of the new corresponding to the original application.

In this embodiment, the management module 12 is configured to launch, when the new application management tag 101 corresponding to the original application is opened, the at least one new application, and generate a derived list, wherein the derived list includes the original application package name ID, a new application list 122, an application name and an application icon, the new application list 122 includes a new application package name ID of the launched at least one new application, and the derived list 121 includes the original application package name ID, the new application package name ID, the application name, the application icon, the self-registration startup capability set.

The file sharing module 14 is configured to obtain, when a mobile terminal shares a file, an application that currently opens the shared file, judge whether the obtained application belongs to the original list, search the derived list 121 for the original applications and/or the new applications corresponding to the obtained application, and display a found application having sharing capability in the original applications and/or the new applications for the user to select.

Specifically, when the mobile terminal shares the file, the file sharing module 14 obtains the application that currently opens the shared file, then judges the obtained application and performs different processing according to the judgment result. This will be described in detail below.

The file sharing module 14 obtains an application that currently opens the shared file when the mobile terminal shares the file, and judges whether the obtained application belongs to the original list 102. When it is judged that the obtained application belongs to the original list 102, the file sharing module judges whether the obtained application has the new application management tag 101. When it is judged that the obtained application does not have the new application management tag 101, the file sharing module obtains at least one original application having the new application management tag 101 in the original list 102, searches the new application list 122 according to the correspondence relation between the original application package name ID of the obtained at least one original application and the new application package name ID, and displays the application name and application icon having the sharing capability set in the original list 102 and the new application list 122 for the user to select.

The file sharing module 14 obtains an application that currently opens the shared file when the mobile terminal shares the file, and judges the obtained application. When it is judged that the obtained application belongs to the original list 102 and has the new application management tag 101, the file sharing module 14 reads the original application package name ID of the obtained application, searches the new application list 122 according to the correspondence relation between the original application package name ID and the new application package name ID, and displays the application name and application icon having the sharing capability set in the new application list 122 for the user to select.

When it is judged that the obtained application does not belong to the original list 102, the file sharing module 14 reads the new application package name ID′ of the obtained application, searches the original application package name ID corresponding to the new application package name ID′, and searches the new application list 122 according to the original application package name ID, and displays the original application and the application name and application icon having the sharing capability set of the new application package name ID, except the new application package name ID′, in the new application list 122 for the user to select.

Hereinafter, by taking the WeChat application installed on the terminal device as an example, the implementation of the sharing function of the WeChat new application corresponding to the WeChat original application by the application sharing device will be described in detail.

The setting module 10 provides an original list that can generate a new application. WeChat installed by the terminal device is in the original list 102, and includes a new application management tag 101. When the new application management tag 101 is opened, the WeChat application can generate a new application WeChat 1 and a new application WeChat 2. The management module 12 starts to operate a process of WeChat 1 and a process of WeChat 2; at the same time, the original application WeChat association derives a new application list 122. The derived list includes information data such as an original WeChat ID, WeChat ID1 (original application package name ID+suffix), WeChat 1, application icon of WeChat 1 and capability set of WeChat 1, and information data such as WeChat ID2, WeChat 2, application icon of WeChat 2 and capability set of WeChat 2.

When a file is shared, a name of an application that opens the file is first obtained. Assuming that the application is an application A, if the application A belongs to the original list 102 and the application A does not have the new application management tag 101 (for example, the application A is a library), then the original application of the WeChat having the new application management tag 101 in the original list 102 is obtained, and the new application list is searched according to the correspondence relation between the original application package name ID of WeChat and the new application package name ID of WeChat. In the end, the found application name (such as WeChat, WeChat 1, WeChat 2) and the application icon having the sharing capability set in the original list and new application list are displayed for the user to select.

If the application A belongs to the original list 102 that can generate a new application and the application A has the new application management tag 101 (for example, the application A is WeChat), the original application package name ID is read, the new application list is searched according to the correspondence relation between the original application package name ID and the new application package name ID, and in the end, all the found application names (such as WeChat 1, WeChat 2) and the application icons having the sharing capability set in the new application list are displayed for the user to select.

If the application A does not belong to the original list that can generate a new application (for example, the application A is WeChat 1), the new application package name ID1 is read, the corresponding new application list 122 is reversely searched for the application package name ID corresponding to the new application package name ID′, then the new application list is searched according to the correspondence relation between the found application package name ID and the new application package name ID, and in the end, the original application and all the found application names (such as WeChat, WeChat 2) and application icons having the sharing capability set of the new application package name ID, except the new application package name ID′, in the new application list are displayed for the user to select.

### Third Embodiment

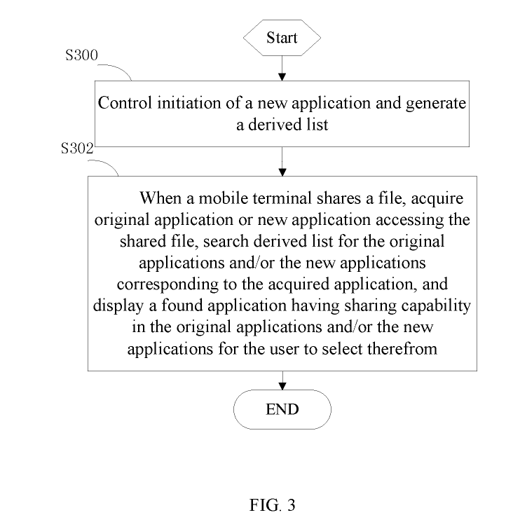

FIG. 3 is a flow chat of an application sharing method according to a third embodiment of the disclosure. The application sharing method in this embodiment is applicable to a mobile terminal, wherein the mobile terminal installs at least one application thereon, and the installed at least one application is an original application. The application sharing method will be described in detail below with reference to FIG. 3. The application sharing method according to this embodiment includes:

Step S300, controlling, by a management module 12, launching of a new application and generating a derived list 121, wherein the new application is the same application operating simultaneously with the original application, and the derived list 121 includes information of the original application and information of the new corresponding to the original application;

Step S302, when a mobile terminal shares a file, obtaining, by a file sharing module 14, an application that currently opens the shared file, searching the derived list 121 for the original applications and/or the new applications corresponding to the obtained application, and displaying a found application having sharing capability in the original applications and/or the new applications for the user to select.

Optionally, the method further includes:

generating an original list, wherein the original list includes the original application that can generate the new application, the original list further includes a new application management tag, and the new application management tag is configured to control whether the original application is authorized to generate a new application, wherein when the new application management tag corresponding to the original application in the original list is opened, the original application can generate the new application.

Optionally, the method further includes:

displaying a found application having the sharing capability in the original applications and/or the new applications for the user to select.

Optionally, the step of controlling the initiation of the new application and generating the derived list includes:

when the new application management tag corresponding to the original application is opened, launching at least one new application, and generating the derived list, wherein the derived list includes the original application package name ID, a new application list, an application name, an application icon, wherein the new application list includes at least one new application package name ID of the launched new application.

Optionally, the method further includes:

judging whether the obtained application belongs to the original list, and when the obtained application belongs to the original list, judging whether the obtained application has the new application management tag;

when the obtained application does not have the new application management tag, obtaining at least one original application having the new application management tag in the original list;

searching the new application list according to the correspondence relation between the original application package name ID of the obtained at least one original application and the new application package name ID, and displaying the application name and application icon having the sharing capability set in the original list and the new application list for the user to select.

Optionally, the method further includes:

when the obtained application belongs to the original list and has the new application management tag, reading the original application package name ID of the obtained application, searching the new application list according to the correspondence relation between the original application package name ID and the new application package name ID, and displaying the application name and application icon having the sharing capability set in the new application list for the user to select.

Optionally, the method further includes:

when the obtained application does not belong to the original list, reading the new application package name ID′ of the obtained application, searching the original application package name ID corresponding to the new application package name ID′, searching the new application list according to the original application package name ID, and displaying the original application and the application name and application icon having the sharing capability set of the new application package name ID, except the new application package name ID′, in the new application list for the user to select.

### Forth Embodiment

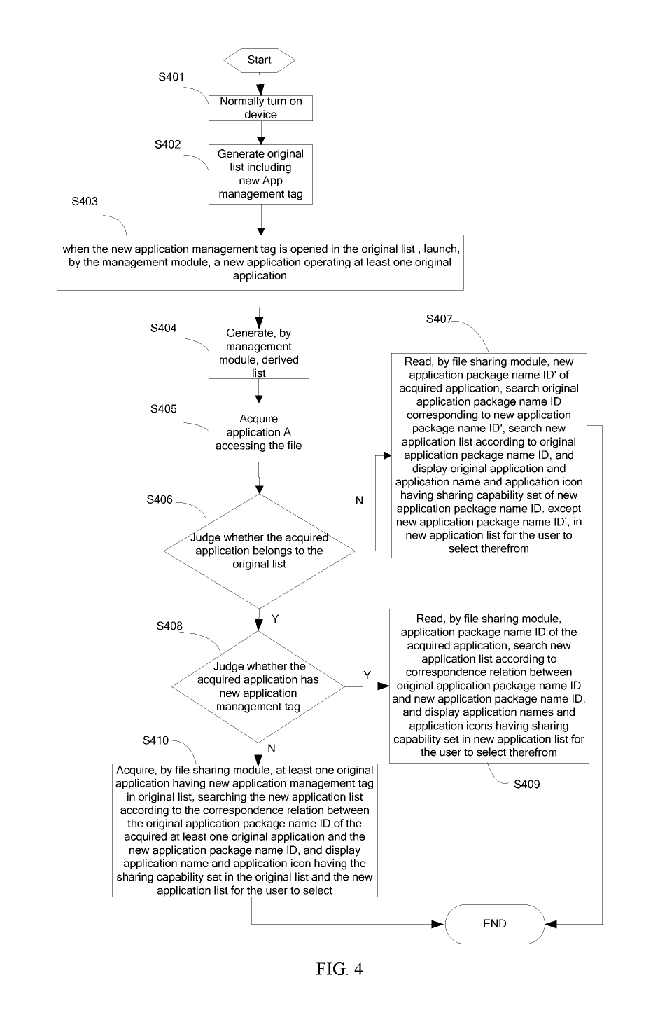

With reference to FIG. 4, FIG. 4 is a flow chat of an application sharing method according to a fourth embodiment of the disclosure, including:

Step S401, normally turning on a device by the system;

Step S402, providing, by a setting module 10, an original list 102 that can generate a new application, wherein the original list 102 includes a new application management tag 101. For example, WeChat is used as the original application, and the management tag 101 of WeChat is turned off by default.

Step S403, when the new application management tag 101 is opened in the original list 102, launching, by the management module 12, a new application operating at least one original application;

For example, when the new application management tag 101 of the WeChat original application is opened, the management module 12 launches the new application process of WeChat 1, and the new application process of WeChat 1 is a process associated with the original application process of WeChat. The system application management list of the mobile terminal is invisible, only the original application process of WeChat can be visible.

Step S404, launching, by the management module 12, to generate the derived list 121, wherein the derived list 121 includes the original application package name ID, a new application list 122, an application name and an application icon, and the new application list 122 includes the launched at least one new application package name ID. For example, a plurality of new WeChat applications corresponding to the original WeChat application are launched, and a new application list 122 is associatively derived. The derived list includes data information such as a WeChat original application package name ID, a package name ID of new application WeChat 1, an icon of WeChat 1, a capability set of WeChat 1.

Step S405, when a file is shared, obtaining the name of the application that opens the file, for example, the application that opens the file is an application A;

Step S406, judging, by the file sharing module 14, whether the application A belongs to the original list 102;

If the application A does not belong to the original list 102, then go to Step S407; if the application A belongs to the original list 102, then go to Step S408;

Step S407, reading, by the file sharing module 14, the new application package name ID′ of the application A, searching the original application package name ID corresponding to the new application package name ID′, searching the new application list 122 according to the original application package name ID, and displaying the original application and the application name and application icon having the sharing capability set of the new application package name ID, except the new application package name ID′, in the new application list 122 for the user to select.

Step S408, judging, by the file sharing module 14, whether the application A has the new application management tag 101, wherein if the application A has the new application management tag 101, go to Step S409, or if the application A does not have the new application management tag 101, go to Step S410;

Step S409, reading, by the file sharing module 14, the application package name ID of the application A, searching the new application list according to the correspondence relation between the original application package name ID and the new application package name ID, and displaying all the found application names and application icons having the sharing capability set in the new application list for the user to select.

Step S410, obtaining, by the file sharing module 14, at least one original application having the new application management tag in the original list, searching the new application list according to the correspondence relation between the original application package name ID of the obtained at least one original application and the new application package name ID, and displaying the application name and application icon having the sharing capability set in the original list and the new application list for the user to select.

An embodiment of the present invention further provides a computer readable storage medium, wherein the computer readable storage medium stores computer executable instructions, and when the computer executable instructions are executed, the application sharing method is implemented.

The application sharing method and device according to the embodiments of the present disclosure can easily complete the process of the file sharing of the new application. With the technical solution of the embodiment of the present disclosure, a new application can be displayed for the user to select when the user clicks the sharing function, thereby solving the lack of sharing function of the current new application and greatly improving the user experience.

An ordinary skill in the art will appreciate that all or a portion of the steps in the above methods may be performed by a program to instruct related hardware (e.g., a processor). The program may be stored in a computer readable storage medium, such as a read-only memory, magnetic disc or optical disc. Alternatively, all or part of the steps in the above embodiments may also be implemented using one or more integrated circuits. Accordingly, each module/unit in the above embodiments may be implemented in the form of hardware, for example, by an integrated circuit to implement its corresponding function, or may be implemented in the form of a software function module, for example, by executing a program/instruction stored in a memory by a processor to implement its corresponding function. This disclosure is not limited to any specific combination of hardware and software. It should be understood by an ordinary skill in the art that the technical solutions of the present disclosure may be modified or equivalently substituted without departing from the spirit and scope of the technical solutions of the present disclosure, and should be constructed with the appended claims.

### INDUSTRIAL APPLICABILITY

The above technical solutions solve the lack of sharing function of current new application, thereby greatly improving the user experience.

1. An application sharing device applicable to a mobile terminal, the mobile terminal installing at least one application, the installed at least one application being an original application, the application sharing device comprising:
a management module, configured to control launching of a new application, and generate a derived list, wherein the new application is the same application operating simultaneously with an original application, and the derived list includes information of the original application, and information of the new application corresponding to the original application; and
a file sharing module, configured to obtain, when the mobile terminal shares a file, the original application or the new application that currently opens the shared file, search the derived list for the original application and/or the new application corresponding to the obtained application.

2. The application sharing device according to claim 1, further comprising:
a setting module, configured to generate an original list, wherein the original list includes the original application that is able to generate the new application, the original list includes a new application management tag, and the new application management tag controls whether the original application is authorized to generate the new application, wherein when the new application management tag corresponding to the original application in the original list is opened, the original application generates the new application.

3. The application sharing device according to claim 1, wherein the file sharing module is further configured to display a found application having sharing capability in the original applications and/or the new applications for the user to select.

4. The application sharing device according to claim 2, wherein the management module is configured to launch, when the new application management tag corresponding to the original application is opened, the at least one new application, and generate the derived list, wherein the derived list includes an original application package name ID, a new application list, an application name and an application icon, wherein the new application list includes a new application package name ID of the launched at least one new application.

5. The application sharing device according to claim 4, wherein the file sharing module is further configured to judge whether the obtained application belongs to the original list, wherein if it is judged that the obtained application belongs to the original list, the file sharing module judges whether the obtained application has the new application management tag, if it is judged that the obtained application does not have the new application management tag, the file sharing module obtains at least one original application having the new application management tag in the original list, searches the new application list according to a correspondence relation between the original application package name ID of the obtained at least one original application and the new application package name ID, and displays an application name and application icon having the sharing capability set in the original list and the new application list for a user to select.

6. The application sharing device according to claim 5, wherein the file sharing module is further configured to read, if it is judged that the obtained application belongs to the original list and has the new application management tag, the original application package name ID of the obtained application, search the new application list according to the correspondence relation between the original application package name ID and the new application package name ID, and display the application name and application icon having the sharing capability set in the new application list for the user to select.

7. The application sharing device according to claim 5, wherein the file sharing module is further configured to read, if it is judged that the obtained application does not belong to the original list, the new application package name ID′ of the obtained application, search the original application package name ID corresponding to the new application package name ID′, and search the new application list according to the original application package name ID, and display the original application and the application name and application icon having the sharing capability set of the new application package name ID, except the new application package name ID′, in the new application list for the user to select.

8. An application sharing method applicable to a mobile terminal, the mobile terminal installing at least one application, the installed at least one application being an original application, the application sharing method comprising:
controlling launching of a new application and generating a derived list, wherein the new application is the same application operating simultaneously with the original application, and the derived list includes information of the original application and information of the new corresponding to the original application; and
obtaining, if a mobile terminal shares a file, the original application or the new application that currently opens the shared file, and searching the derived list for the original applications and/or the new applications corresponding to the obtained application.

9. The application sharing method according to claim 8, further comprising:
generating an original list, wherein the original list includes the original application that is able to generate the new application, the original list further includes a new application management tag, and the new application management tag is configured to control whether the original application is authorized to generate the new application, wherein if the new application management tag corresponding to the original application in the original list is opened, the original application generates the new application.

10. The application sharing method according to claim 8, further comprising:
displaying a found application having the sharing capability in the original applications and/or the new applications for the user to select.

11. The application sharing method according to claim 9, wherein the step of controlling the initiation of the new application and generating the derived list comprises:
if the new application management tag corresponding to the original application is opened, launching at least one new application and generating the derived list, wherein the derived list includes the original application package name ID, a new application list, an application name, an application icon, wherein the new application list includes at least one new application package name ID of the launched new application.

12. The application sharing method according to claim 11, further comprising:
judging whether the obtained application belongs to the original list, and if the obtained application belongs to the original list, judging whether the obtained application has the new application management tag;
if the obtained application does not have the new application management tag, obtaining at least one original application having the new application management tag in the original list; and
searching the new application list according to the correspondence relation between the original application package name ID of the obtained at least one original application and the new application package name ID, and displaying the application name and application icon having the sharing capability set in the original list and the new application list for the user to select.

13. The application sharing method according to claim 12, further comprising:
if the obtained application belongs to the original list and has the new application management tag, reading the original application package name ID of the obtained application, searching the new application list according to the correspondence relation between the original application package name ID and the new application package name ID, and displaying the application name and application icon having the sharing capability set in the new application list for the user to select.

14. The application sharing method according to claim 12, further comprising:
if the obtained application does not belong to the original list, reading the new application package name ID′ of the obtained application, searching the original application package name ID corresponding to the new application package name ID′, searching the new application list according to the original application package name ID, and displaying the original application and the application name and application icon having the sharing capability set of the new application package name ID, except the new application package name ID′, in the new application list for the user to select.
